(19) United States
(12) Patent Application Publication
(10) Pub. No.: US 2006/0156552 A1
(43) Pub. Date: Jul. 20, 2006

(54) Protective shield for a cutting tool of a brushcutter or trimmer

(75) Inventor: Thorsten Schilling, Esslingen (DE)

Correspondence Address: ROBERT W. BECKER & ASSOCIATES, Suite B, 707 Highway 66 East, Tijeras, NM, 87059, US

(73) Assignee: Andreas Stihl AG & Co. KG, Badstrasse, Waiblingen (DE)

(21) Appl. No.: 11/314,434

(22) Filed: Dec. 21, 2005

(30) Foreign Application Priority Data
Dec. 28, 2004 (DE) 10 2004 063 723.7

(51) Int. Cl. B26B 7/00

(52) U.S. Cl. 30/276

(57) ABSTRACT

A protective shield for a cutting tool of a brushcutter or trimmer, wherein in the region of the working end of a guide tube, the cutting tool is mounted so as to be rotatable in a turning circle about an axis of rotation. A radial wall extends radially relative to the axis of rotation and at least partially shields the turning circle in an axial direction. A support channel is formed in the radial wall for receiving the working end of the guide tube. A peripheral wall adjoins the radial wall and at least partially shields the turning circle in a radial direction.

The instant application should be granted the priority date of Dec. 28, 2004, the filing date of the corresponding German patent application 10 2004 063 723.7.

### BACKGROUND OF THE INVENTION

The present invention relates to a protective shield for a cutting tool of a brushcutter or trimmer.

The cutting tool is mounted on the gear unit of a brushcutter or trimmer in such a way as to be rotatable in a turning circle about an axis of rotation. During operation, the cutting tool is rotated at high speed by a drive motor. When grass, branches, or other plant material is being cut, the high cutting speed causes the cut material, small stones that are churned up, or the like to be thrown or flung out. To protect the operator, a protective shield is provided that is attached to the brushcutter in the region of the gear unit, and which at least partially shields the cutting tool in the direction of the operator.

US 2002/0078573 A1 discloses a brushcutter having a gear unit that is provided with a shaft that projects at an angle relative to the axis of rotation of the cutting tool. The gear unit is secured to a guide tube by means of the shaft, and a drive shaft is rotatably mounted in the guide tube. A miter gear in the gear unit transfers the rotational movement of the drive shaft that is mounted in the guide tube to the cutting tool. A protective shield is provided that has a radial wall, which extends radially relative to the axis of rotation of the cutting tool and partially covers the turning circle in the axial direction, and also has a peripheral wall that adjoins the radial wall and partially covers the turning circle in a radial direction. The protective shield is attached to the guide tube directly adjacent to the shaft of the gear unit.

The particles that are flung up subject the protective shield to abrasive wear. For maintenance, cleaning and replacement operations, an ability to easily assemble or disassemble is desirable.

It is therefore an object of the present application to provide for the gear unit of a brushcutter or trimmer a protective shield that can be easily mounted or disassembled in a precisely positioned manner.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective view of a brushcutter or trimmer in the region of its gear unit, including a protective shield that is mounted on the shaft thereof;

FIG. 2 is a cross-sectional view through the arrangement of FIG. 1 in the region of the gear unit, including details of a trough-like snap connection of the protective shield;

FIG. 3 is a side view of the arrangement of FIG. 1 with the protective shield removed; and

FIG. 4 shows the arrangement of FIG. 3 with the protective shield snapped on, and also shows details of the relative position of its radial wall.

### SUMMARY OF THE INVENTION

A protective shield for a cutting tool of a brushcutter or trimmer is provided, wherein in the region of the working end of the guide tube thereof, the cutting tool is mounted so as to be rotatable in a turning circle about an axis of rotation. The protective shield has a radial wall that extends radially relative to the axis of rotation, with the radial wall at least partially shielding the turning circle in an axial direction. A support channel is formed in the radial wall for receiving the working end of the guide tube. A peripheral wall adjoins the radial wall and at least partially shields the turning circle in a radial direction.

In the assembled state, the working end of the guide tube, which is in particular formed by the shaft of the gear unit, rests flushly in the channel, i.e. in a substantially surface-to-surface manner. An at least partially interlocking configuration is provided that simplifies a relative positioning of the protective shield relative to the gear unit or its cutting tool during assembly.

Pursuant to an advantageous further development, a snap connection is provided for the attachment of the protective shield on the shaft. The snap connection is in particular formed by a cross-section of the support channel that at its open side is narrower than a maximum cross-sectional width of the working end or shaft of the gear unit. Assembly and disassembly are effected in a simple manner by snapping the support channel onto the shaft of the gear unit. A simultaneous attachment and fixing of the position relative to the gear unit or the cutting tool result. Additional attachment means, such as screws, bayonet closures, or the like, merely serve for a securement of the snap connection.

In the region of the support channel, the radial wall is expediently raised via such an axial directional component that it extends at least approximately parallel to a longitudinal axis of the support channel. In this region, lateral wings of the radial wall adjoin the support channel and support it in the lateral direction. A bowing or spreading of the channel cross-section under load is prevented. The high clamping force effected thereby reliably holds the protective shield in a precise position.

Pursuant to an expedient embodiment, means are provided for a positive securement of the protective shield in the axial direction of the shaft. These means for the positive axial securement preferably include radially inwardly projecting ridges of the support channel which are provided for resting, in a direction facing toward the free end, against a free end of the shaft and/or against a peripheral widened portion of the shaft. Alternatively, or in addition thereto, the means for the positive axial securement can include a support nose that is provided for resting against a surface of the gear unit that is disposed parallel to the turning circle. An exact fixing of the position of the protective shield in the axial direction of the shaft of the gear unit is formed. An axial alignment of the protective shield during assembly can be eliminated, thereby further reducing assembly effort.

Pursuant to an advantageous further development, means are provided for positively preventing the protective shield from rotating about the shaft of the gear unit. The means for the positive protection against rotation are expediently formed by a pair of the aforementioned support noses which are provided for resting against the surface of the gear unit that is disposed parallel to the turning circle. The pair of support noses, which is advantageously disposed in an extension of the side edges of the support channel, is guided along both sides of the shaft of the gear unit in a fork-shaped manner. The support on the aforementioned surface simultaneously effects an axial orientation and a protection against rotation. An erroneous assembly is prevented. Rather, during the assembly the protective shield can be positioned and attached without any great requirements for precision. When the protective shield is snapped on, the pair of support noses effects an automatic orientation in the direction of rotation and in the axial direction.

As securement, and to absorb unexpectedly high forces that can occur during operation due to inadvertent bumping of the protective shield or in a similar manner, it can be expedient to provide a safety screw, which is in particular provided for screwing through the support channel and into the shaft of the gear unit.

Further specific features of the present application will be described in detail subsequently.

### DESCRIPTION OF SPECIFIC EMBODIMENTS

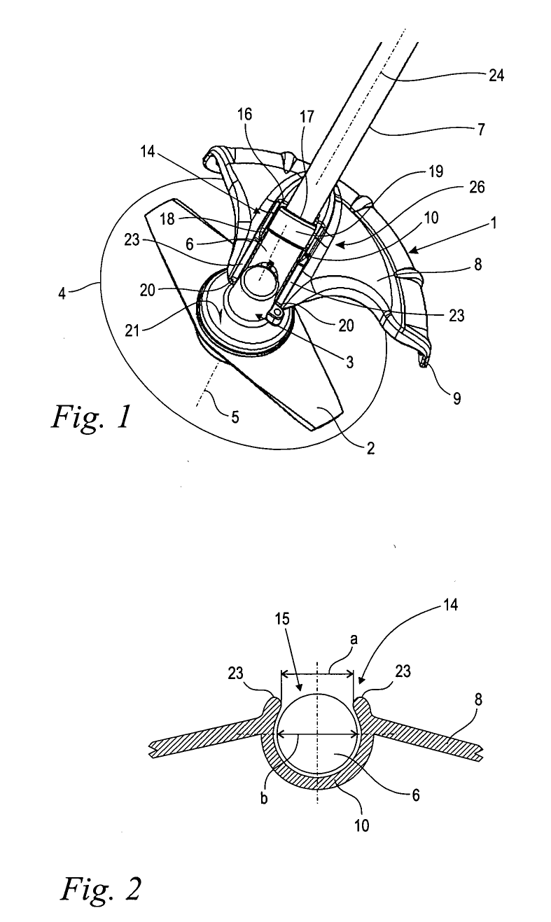

Referring now to the drawings in detail, the perspective illustration of FIG. 1 shows a brushcutter or trimmer in the region of its gear unit 3. This gear unit 3 is provided with a shaft 6 that projects at an angle to the axis of rotation 5 and by means of which the gear unit is secured to a guide tube 7 of the brushcutter. Mounted in the guide tube 7 is a non-illustrated drive shaft that transfers the rotational movement of a drive motor to a non-illustrated miter gear that is disposed in the gear unit 3.

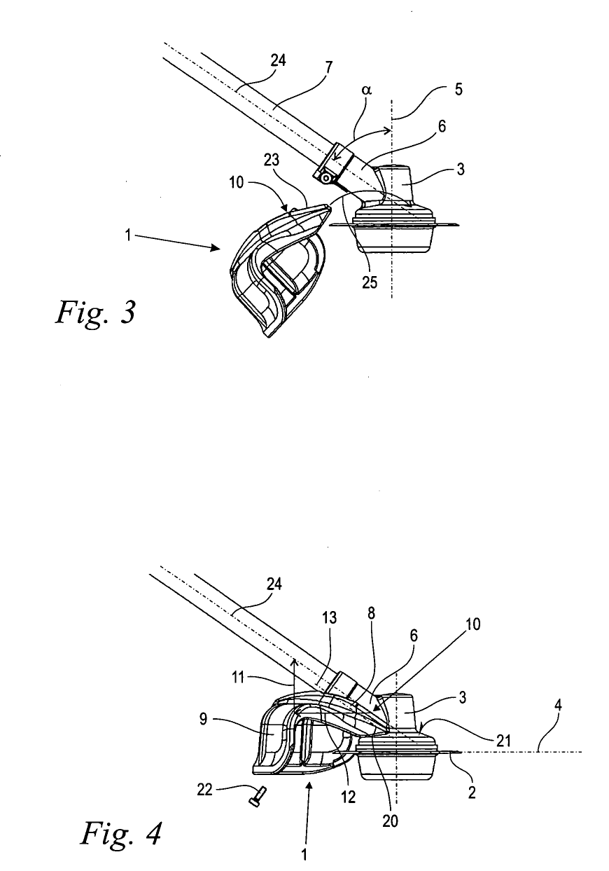

The shaft 6 forms a working end 26 of the guide tube 7. A cutting tool 2 is provided that is mounted on the gear unit 3 in such a way as to be rotatable about the axis of rotation 5. As can be seen from FIG. 3, the miter gear is disposed at an appropriate angle α; the miter gear brings about the rotation of the cutting tool 2 about the axis of rotation 5, whereby the cutting tool 2 describes a turning circle 4. In the illustrated embodiment, the cutting tool 2 is in the form of a cutting blade. It could also be a circular saw blade, a cutting or trimmer filament, or the like.

Attached to the gear unit 3 of the brushcufter is a protective shield 1, which includes a radial wall 8 and a peripheral wall 9. The protective shield 1 can also be attached directly to the guide tube 7 in the vicinity of the working end 26. The radial wall 8 extends approximately parallel to and above the turning circle 4 over a limited angular range that is directed toward the operator. Radially outwardly, the radial wall 8 is adjoined by the peripheral wall 9, which is angled off downwardly, extends over the same angular range, and which extends to below the turning circle 4 (see FIG. 4). The protective shield 1 thereby covers the turning circle 4, i.e. the cutting tool 2, over the aforementioned angular range, in the axial direction upwardly via the radial wall 8, and in the radial direction toward the rear via the peripheral wall 9.

Centrally formed in the radial wall 8 is an indicated trough-shaped support channel 10 which is described in greater detail in conjunction with FIG. 2, and into which is placed the shaft 6 of the gear unit 3. Lateral edges 23 of the support channel 10 extend on both sides of and parallel to the shaft 6. At their free ends that face the gear unit 3, the edges 23 respectively merge into a support nose 20 that rests against a surface 21 of the gear unit 3 that is disposed approximately parallel to the turning circle 4.

At its free end, the shaft 6 of the gear unit 3 is provided with a widened portion 19 that serves for a clamping screw-fastening of the gear unit 3 on the guide tube 7. Two circumferential, radially inwardly projecting ridges 16, 18 are formed in the support channel 10. The ridge 16 that is disposed remote from the gear unit 3 is disposed against the free end 17 of the shaft 6 relative to the axial direction thereof. In the axially opposite direction from the free end 17 the further ridge 18 rests against the widened portion 19. The ridges 16, 18, together with the fork-shaped pair of support noses 20, form means for the axial securement or fixation of the protective shield 1 relative to the longitudinal axis 24 of the shaft 6 and the guide tube 7. As a consequence of the lateral spacing from the longitudinal axis 24, the two support noses 20, due to the fact that they rest against the surface 21, also form a positive protection against rotation of the protective shield 1 about the longitudinal axis 24.

Provided in the region of the widened portion 19 is a snap connection 14 by means of which the protective shield 1 is attached to the shaft 6 of the gear unit 3. Details of the snap connection 14 are shown in the schematic cross-sectional view of FIG. 2, which is a cross-section through the shaft 6 and the adjoining region of the radial wall 8 with its support channel 10. To facilitate understanding, the support channel 10, which is approximately U-shaped in cross-section, is shown in FIG. 2 with a slight radial play relative to the shaft 6. However, in the practical embodiment the support channel 10 rests flushly against the shaft 6 under radial pre-tension. The shaft 6 has an approximately circular cross-section. This cross-section, or some other suitable cross-section, follows the cross-sectional contour of the support channel 10. As a result of the two lateral edges 23 of the support channel 10, an open side 15 of its cross-section having an inside width a is formed. The inside width a is less than a maximum cross-sectional width b of the shaft 6. The radial wall 8 merges into the formed-n support channel 10 in the vicinity of the two lateral edges 23, as a result of which the cross-section of the support channel 10 is reinforced against a lateral spreading-apart of the two edges 23. The difference in dimension between the inside width a and the cross-sectional width b is such that within the limit of the retained elastic deformability, the support channel 10 can be snapped onto the shaft 6 via its open side 15, thereby forming the snap connection 14. By means of the snap connection 14, the ridges 16, 18 and the support noses 20 (FIG. 1), the protective shield 1 is reliably fixed on the gear unit 3 in all spatial directions and about all spatial axes.

The side view of FIG. 3 shows the arrangement of FIG. 1 with the protective shield 1 removed. As can be seen, the longitudinal axis 24 of the shaft 6 and also of the guide tube 7 is disposed at an angle α relative to the axis of rotation 5, whereby in the illustrated embodiment the angle a is approximately 45°.

For mounting the protective shield 1, it is placed in the illustrated inclined position and is snapped onto the shaft 6 via its support channel 10 in such a way that the two lateral edges 23 of the support channel 10 are guided laterally past the shaft 6 along a curved arrow 25 until they assume the position shown in FIG. 4.

From the illustration of FIG. 4, it can be seen that the surface 21 of the gear unit 3, on which surface the two support noses 20 are supported in a direction of the longitudinal axis 24 of the shaft 6, has a slightly conical shape, yet on the whole is disposed at least approximately parallel to the turning circle 4 of the cutting tool 2.

Relative to the side view shown here, the radial wall 8 has a swung configuration, whereby in the region of the shaft 6, approximately over the length of the support channel 10, the radial wall 8, from the horizontal formed by the turning circle 4, rises from the gear unit 3 in a direction toward the peripheral wall 9. The rising contour is described by a radial directional component 12 and an axial directional component 11. The radial wall 8 rises with an axial directional component 11 that is such that in this region the radial wall extends at least nearly parallel to the longitudinal axis 13 of the support channel 10, which in turn is parallel to the longitudinal axis 24 of the shaft 6.

To provide additional securement, a safety screw 22, which is illustrated in the not-yet installed state, is also provided. The safety screw 22 is screwed through the support channel 10 and into the shaft 6 of the gear unit 3.

The specification incorporates by reference the disclosure of German priority document 10 2004 063 723.7 filed Dec. 28, 2004.

The present invention is, of course, in no way restricted to the specific disclosure of the specification and drawings, but also encompasses any modifications within the scope of the appended claims.

What I claim is:

1. A protective shield for a cutting tool (2) of a brushcutter or trimmer, wherein in the region of a working end (26) of a guide tube (7) of said brushcutter or trimmer, said cutting tool (2) is mounted so as to be rotatable in a turning circle (4) about an axis of rotation (5) said protective shield comprising:
a radial wall (8)that extends radially relative to said axis of rotation (5) wherein said radial wall (8) at least partially shields said turning circle (4) in an axial direction, wherein a support channel (10) is formed in said radial wall (8) and wherein said support channel (10) is provided for placement of said working end (26) of said guide tube (7) therein; and
a peripheral wall (9) that adjoins said radial wall (8), wherein said peripheral wall (9 ) at least partially shields said turning circle (4) in a radial direction.

2. A protective shield according to claim 1, wherein a gear unit (3) is provided for said cutting tool (2), wherein said gear unit (3) is provided with a shaft 6 that projects therefrom at an angle to said axis of rotation (5), wherein said shaft (6) is adapted to be secured to said working end (26) of said guide tube (7), and wherein said support channel (10) is adapted to be attached to said shaft (6) of said gear unit (3).

3. A protective shield according to claim 2, wherein said support channel (10) forms a snap connection (14) for attachment to said shaft (6) of said gear unit (3).

4. A protective shield according to claim 3, wherein said snap connection (14) is formed by a cross-section of said support channel (10) that at an open side (15) is narrower than a maximum cross-sectional width (b) of said working end (26) of said guide tube (7).

5. A protective shield according to claim 1, wherein in the region of said support channel (10) said radial wall (8) is raised via such an axial directional component (11) that said radial wall (8) extends at least approximately parallel to a longitudinal axis (13) of said support channel (10).

6. A protective shield according to claim 2, wherein means are provided for a positive securement of said protective shield in an axial direction of said working end (26) said guide tube (7).

7. A protective shield according to claim 6, wherein said means for a positive axial securement include a radially inwardly projecting ridge (16) of said support channel (10) that is adapted to rest against a free end (17) of said shaft (6) of said gear unit (3).

8. A protective shield according to claim 6, wherein said shaft (6) of said gear unit (13) is provided with a circumferentially extending widened portion (19) and wherein said means for a positive axial securement includes a radially inwardly projecting ridge (18) of said support channel (19) that is adapted to rest against said widened portion (19) of said shaft (6) in a direction facing a free end (17) of said shaft (6).

9. A protective shield according to claim 6, wherein said means for a positive axial securement includes a support nose (20) that is adapted to rest against a surface (21) of said gear unit (3) that is disposed parallel to said turning circle.

10. A protective shield according to claim 2, wherein means are provided for preventing rotation of said protective shield about said shaft (6) of said gear unit (3).

11. A protective shield according to claim 10, wherein said means for preventing rotation are formed by a pair of support noses (20) that rests against a surface (21) of said gear unit (3) that is disposed parallel to said turning circle (4).

12. A protective shield according to claim 1, wherein a safety element (22) is provided for securement of said protective shield.

13. A protective shield according to claim 12, wherein said safety element is a safety screw (22).

14. A protective shield according to claim 2, wherein a safety screw (22) is provided for securement of said protective shield, and wherein said safety screw (22) is adapted to be screwed through said support channel (10) and into said shaft (6) of said gear unit (3).
